(19) United States
(12) Patent Application Publication
(10) Pub. No.: US 2013/0103663 A1
(43) Pub. Date: Apr. 25, 2013

(54) NETWORKED MIND MAPPING TO ENHANCE BRAINSTORMING

(71) Applicants: Jishai Evers, Tel Aviv (IL); Gilad Manor, Tel Aviv (IL)

(72) Inventors: Jishai Evers, Tel Aviv (IL); Gilad Manor, Tel Aviv (IL)

(73) Assignee: WIKIBRAINS, LTD., Tel Aviv (IL)

(21) Appl. No.: 13/279,263

(22) Filed: Oct. 22, 2011

(51) Int. Cl. G06F 17/30

(52) U.S. Cl. 707/706; 707/770; 707/E17.014; 707/E17.108

(57) ABSTRACT

Individual participants in a brainstorming session collectively build a mind map representing their individual contributions and joint conclusions. The participants communicate via a network, such as the Internet, to enable convenient participation from different physical locations. Information recorded by one participant instantly becomes available to the other participants in a convenient manner. Brainstorming session participants access a system of at least one server and data base through a network to access the mind map. The participants also have convenient access to resources, such as Internet search engines, as they collaborate, and they have convenient methods to record information for immediate access by the other participants. With such functionality available, an individual participant can contribute to the brainstorming session at times that are convenient to himself/herself, because it is not necessary that all participants attend a session at the same time.

### BACKGROUND

Brainstorming is a group activity intended to foster synergism. Individual participants work to find solutions to problems and/or to develop creative ideas in reaching either general or specific goals. Individuals acting alone will often begin developing ideas and typically stagnate temporarily at certain points in the development process as they try to pass particular hurdles. However, individuals working together assist each other, providing alternate suggestions from different perspectives, and overcome hurdles faster than any of the individuals acting alone would have overcome them.

Brainstorming sessions in the past typically transpired with the individual members of the group meeting, perhaps in a conference room, with at least one member recording the individual contributions and the group conclusions. Although each member brought his/her innate creativity, those wishing to prepare in advance for the brainstorming session had to acquire and physically bring to the session resources, such as pertinent books and published articles. The resources may or may not have been shared beforehand with other members of the group, but it was the option to loan a resource to another group member for use after a session to enable the other member to better prepare for the resumption of the brain storming.

Brainstorming was appreciated as effective, not just in office settings, but also in home and social settings, and this effectiveness was regularly judged as worth the efforts of coordinating meetings at times and places that would be convenient, or at least tolerable, for all of the group members. With the advent of conference calling and video-conferencing, brainstorming sessions could be held with members located in different locations, even in different parts of the world.

It is still necessary though to have an effective and convenient way for group members to present their ideas to each other. Voice- and video-conferencing can convey the voice, facial expressions, and body gestures of the meeting participants, and software applications can now make presentation slides and movies available in real time to the other group members in other physical locations.

However, although computer conferencing applications can be implemented to enable participation in brainstorming sessions from multiple locations around the world, it would still be desirable to find a suitable alternative to the problem of finding convenient times for each of the participants. Also, there needs to be more convenient ways to record the final conclusions and “intermediate conclusions” of brainstorming sessions to reduce the reliance on the subjective efforts of one or of a few designated note takers. Further, a brainstorming session could benefit from convenient ways to access pertinent information and to immediately present it for consideration by the group. The present inventors are unaware of such desired functionality being available conventionally.

### SUMMARY

Accordingly, the present inventors have developed a way to foster the teamwork of individuals in brainstorming sessions to enable the convenient exchange of ideas, resources, and mutual suggestions among individual members. Ideas are instantly recorded and made available to all participants. Further, because ideas at all times are recorded so easily and available instantaneously for subsequent presentation to individuals at their convenience, a brainstorming effort does not necessarily require that all group members participate at the same time. An individual can view the state of the problem-solving effort at a convenient time for him/her and contribute ideas accordingly for the others to view and use as bases for their subsequent contributions. The tools developed by the inventors can also be exploited by individuals acting alone to access thoughts and suggestions that originated from other individuals at earlier times, even if the individuals acting earlier did not anticipate that their work would be used later by others that they may not have even known.

The invention may be embodied as a system for storing and retrieving information. The system has one or more databases and one or more servers. The one or more databases are for storing mind maps that have nodes and relationships between the nodes. The one or more servers are under common control and control access to the one or more databases. The one or more servers also, through a network, communicate with a first client computer of a first user. The one or more servers are operative to receive a request from the first user to load a mind map on a display of the first client computer, to send instructions to the first client computer to display at least a first node of the mind map, and, upon request from the first user, to send to the first client computer instructions to display (1) an additional node of the mind map, (2) a relationship between the first node and the additional node, and (3) at least one of (i) an information window and (ii) suggestions for another node to create. The information window displays search results associated with the first node, with the additional node, or with the relationship and enables the first user to enter for storage on the one or more databases data based on the search results and data independent of the search results. The suggestions for another node are provided by accessing the one or more databases. The search results and/or the suggestions include data that a second user has provided to the one or more controlled-access databases using a second client computer.

The invention may also be embodied as a method of storing and retrieving information. The method includes: controlling access to one or more servers and to one or more databases; receiving at the one or more servers a request from a first user to load a mind map on a display of a first client computer; sending from the one or more servers instructions to display at least a first node of the mind map on the display; and upon request from the first user, sending from the one or more servers instructions to display on the display (1) an additional node of the mind map, (2) a relationship between the first node and the additional node, and (3) at least one of (i) an information window and (ii) suggestions for another node to create. The information window displays search results associated with the first node, with the additional node, or with the relationship and enables the first user to enter for storage on the one or more databases data based on the search results and data independent of the search results. The suggestions for another node are provided by accessing the one or more controlled-access databases. The search results and/or the suggestions include data that a second user has provided to the one or more controlled-access databases using a second client computer.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates an example of the invention embodied as a system for storing and retrieving information;

FIG. 2 illustrates a mind map that may be created and maintained using embodiments of the present invention, including that represented in FIG. 1;

FIG. 3 presents a diagram illustrating how users may access the system of FIG. 1 through the Internet;

FIG. 4 illustrates an information window of embodiments of the invention, including the embodiment of FIG. 1;

FIG. 5 illustrate how an option window is opened for relationships of the mind map of FIG. 2; and

FIG. 6 presents a flow chart representing a method according to an alternate embodiment of the invention.

### DETAILED DESCRIPTION

The invention summarized above and defined by the claims below will be better understood by referring to the present detailed description of embodiments of the invention. This description is not intended to limit the scope of claims but instead to provide examples of the invention. Described first is a system embodiment with many variations. Described later is a method embodiment.

A first embodiment of the invention is a system for storing and retrieving information. In this embodiment, multiple users participate in collaborative brainstorming in what can be regarded as a single session. In other embodiments, as discussed later, a lone user can access information that others have contributed in the past with the effect of that “lone” user essentially participating in a brainstorming station with potentially all users that have ever contributed to the system.

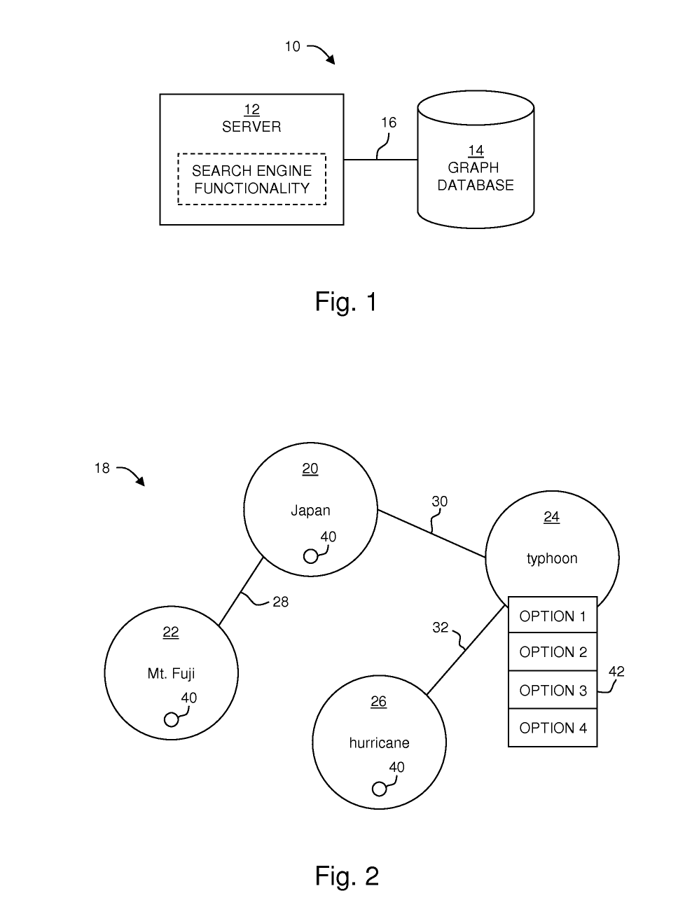

The first embodiment, as illustrated in FIG. 1, is a system 10 includes a server 12 operationally connected to a graph database 14, for example, by a USB cable 16. The server 12 controls user access to the graph database 14. The graph database 14 is configured to store mind maps, such as the example discussed below and illustrated in FIG. 2.

Example hardware elements of the server 12 include an Intel® Core™ i5 or i7 processor and a 250 GB hard drive, such as that available in the Dell PowerEdge or HP ProLiant series. These example servers can be run using Windows or Linux. In alternate embodiments, the functions performed by the server 12 may instead be performed by multiple servers, such as a service provided by a cloud computing solution. In this case, the servers work together under a common control with access thereto controlled by a single entity or by independent entities in the array of servers.

Example peripherals of the server 12 where the graph database 14 may reside include 3.5″ PATA or SATA desktop hard drives, which as shown in FIG. 1 and as discussed above are connected to the server 12 by a USB cable 16. In alternate embodiments, the graph database may reside within its server's internal storage, such as in a Linux environment. In still other alternate embodiments, the database may reside on a separate server that is connected to the primary server (such as the server 12) via an Ethernet cable connected to an Ethernet adapter.

Regarding example databases to use for implementation of the present embodiment, a CouchDB database may be used as the graph database 14 of FIG. 1. The invention is not limited accordingly, though, and relational database, such as MySQL, Oracle, IBM DB2, and SQLight databases, may be used instead. Further, multiple graph databases and/or multiple databases of various types may be implemented in alternate embodiments in place of the graph database 14. The access to the multiple databases would be controlled by the server 12. (When multiple databases are used, the data for nodes, relationships, information windows, et cetera associated with a single mind map may be distributed over the multiple databases. That is, the particular mind map would not be stored on a single database.)

The graph database 14 stores mind maps that are created and maintained using the server 12. The general concept of a mind map is known in the art, and commercial software is available to create and maintain conventional mind maps. Examples of such software include ThinkBuzan (iMindMap), SmartDraw, and CAM editor. As the non-limiting example mind map illustrated in FIG. 2 shows, a mind map 18 stored in the graph database 14 may include a set of nodes 20, 22, 24, 26 with individual nodes connected to each other by relationships 28, 30, 32.

The nodes 20, 22, 24, 26 and the relationships 28, 30, 32 arranged graphically on a computer display a set of thoughts to be guided to solve a particular problem. For example, a planning committee of an entertainment company may be brainstorming for ideas for a mini-series to broadcast about Japanese culture to an American television audience. Typically, one committee member will begin by creating a node for the mind map. A node represents a concept, such as a name, idea, key word, vacation site, or mood. In this example, the first node 20 is given the label “Japan.”

Continuing with this example, another member of the brainstorming team thinks of the popularity in America of nature and outdoor pastimes, and, more specifically, he thinks of Mt. Fuji. Thus, he creates the node 22 and labels “Mt. Fuji.” He connects the node 20 to node 22 with the relationship 28. The relationship 28 shows committee members that at least one member considered the concepts of the nodes 20, 22 to have a logical connection. (Although this may be obvious when a mind map has only two nodes, it may not be so obvious how the nodes relate to each other as the number of nodes increase.) Stated differently, nodes can be regarded as “clues” to the brainstorming solution, and relationships between the nodes can be considered “glue.” A common mind map synonym for “relationship” is “edge.”

It is noted that an individual contributing to the mind map 18 is not a series of steps that necessarily must supplant the practice of individuals discussing amongst themselves the relationships of various ideas. During the discussions, however, the simultaneous evolution of a mind map visible to all individuals augments the group effort.

The mind map 18 grows further with a third committee member, not dismissing categorically the idea of the second committee member, thinking of a hurricane endured recently by a significant number of Americans and then concluding that a feature report of the Japanese dealing with the hardship of a typhoon may interest many viewers. Accordingly, the third committee member creates the node 24, labels it “typhoon,” and creates the relationship 30 connecting the new node 24 to the Japan node 20. She then creates node 26 and labels it “hurricane.” She also creates the relationship 32 connecting the hurricane node 26 to the typhoon node 24 instead of to the Japan node 20, because she thinks of the hurricane concept as the American counterpart to the Japanese typhoon and thus more appropriately connected in the mind map accordingly. (It is acknowledged that by strict definition a hurricane and a typhoon might be essentially the same, but the use of the terminology typically used by a particular region where an event occurred might prove advantageous using the tools discussed below.)

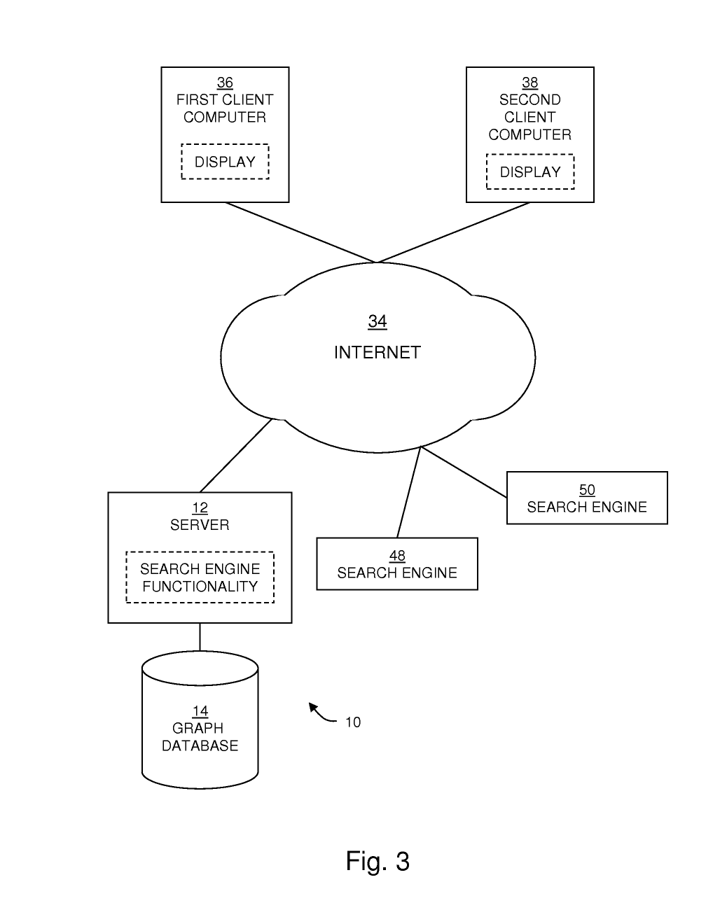

To enable access to the mind map 18 and thus to the brainstorming session to multiple users located in different locations, the system 10 may be connected to the Internet 34 as shown in FIG. 3. Committee members access the system 10 via the Internet 34 using client computers. For example, a first user uses a first client computer 36, and a second user uses a second client computer 38. Many more client computers may be used by users/committee members joining the brainstorming session, but for clarity only two are illustrated in FIG. 3. Users simultaneously at a shared site may elect to share a single client computer, but a user at another site will obviously need different client computer if simultaneous participation of the committee members is desired.

(Although the Internet 34 is used in the present embodiment, the invention may be embodied using other networks. Example networks include an intranet or LAN of a large enterprise and a cellular communication network. Even a network of two computers may be implemented. The networks would simply need to be able to allow access to a suitable database.)

The term “client computer” refers to any platform capable of providing the functionality described herein. As non-limiting examples, a client computer may be a personal computer, a smartphone, or a tablet.

The server 12 controls access of the users to the graph database 14. As partially noted above, if multiple servers were to be used in place of the single server 12, a single entity, such as a system administrator, can restrict access to the brainstorming session to authorized users only or instead may allow free access to the session to the general public. Similarly, if multiple databases are used instead of only the graph database 14, the system administrator can control all access thereto.

Accordingly, when the system 10 is implemented as shown in FIG. 3, the server 12 is operative to communicate with the first user's client computer 36 through the Internet 34, for example, to receive requests from the first user to load mind maps on the first client computer's display. To “load” a mind map in this context means either to create a new mind map or to retrieve a mind map that is already created and stored on the graph database 14. As will be apparent below, the first user may request that the server 12 load a mind map that was created by the second user using the second client computer 38. Upon receipt of the first user's request, the server 12 sends to the first client computer 36 instructions to display the mind map. If the user is creating a new mind map, the instructions will initially cause the first client computer 36 to display the first node. If the user is retrieving an existing mind map, the instructions will most likely cause the first client computer 36 to display multiple nodes and interconnecting relationships. Also upon request from the first user, the server 12 sends instructions to display additional nodes of the mind map and relationships between the nodes on the display of the first client computer 36.

With reference again to the mind map 18 of FIG. 2, the nodes 20, 22, 24, 26 of this embodiment each have an option button 40. Upon user selection thereof (for example, by a mouse click when the mouse cursor is positioned over the option button 40), a menu opens offering multiple options for the users in building the mind map 18. In FIG. 2, the option button for the typhoon node 24 was selected and thus the option menu 42 is displayed. Options offered by the menu 42 include adding a new node to the mind map 18 as related directly to the selected node, deleting the selected node, and adding a new relationship whereby the selected node will be directly connected to another existing node. There may even include the option of accessing another “dimension” of a node; that is, the display would be cleared of all non-selected nodes to create room to see more new nodes, and the user will have the option of returning to the former display and seeing the formerly-selected node with the other nodes except for those nodes create while in the other dimension.

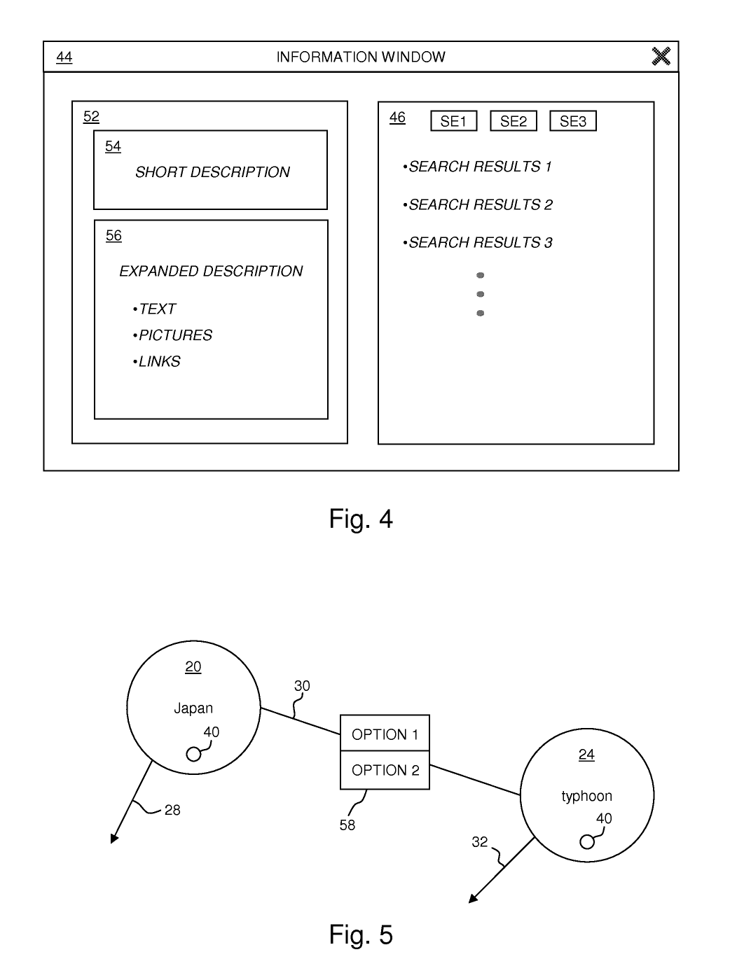

To assist a user's brainstorming efforts, the user may select an entry of the option menu 42 that causes the server 12 to instruct the user's client computer to display an information window 44 as shown in FIG. 4. (In practice, an information window may also be referred to as an “info-box.”) As each node has a label, the information window 44 displays search results associated with the selected node by using the label of that node as a search term for a search engine. The information window 44 in this example embodiment is illustrated as providing the user in a region 46 with options of the resources SE1, SE2, and SE3 (selected when the cursor is positioned over the particular option) as the particular search engine to use, with search engine SE1 and SE2 corresponding to the search engines 48 and 50 shown in FIG. 3. Example search engines of this type are those of Google, Lycos, and Yahoo! that access and search the Internet. Other example resources are dedicated search engines that search the databases of Twitter or any other given (information) source. The search results are also displayed in the region 46 of the information window 44.

Although the invention is not limited as such, the server 12 in this embodiment has search engine functionality. When the server 12 causes the display of an information window 44 on the client computer 36, the user has the option of using this search engine functionality as option SE3 (FIG. 4) to search the graph database 14 for information relating to a node. The search engine functionality is provided by a set of algorithms that traverse on the graph database 14 to access relevant data stored thereon.

In the information window 44, the user can record notes that he/she deems useful in a region 52 in either a sub-region 54 or in a sub-region 56. The sub-region 54 in this embodiment is intended for brief notes, for example, notes of no more than 140 characters, and the sub-region 56 can accept larger comments. Image files and hyperlinks may also be added to the sub-region 56 as desired to aid in brainstorming efforts.

Thus, the information window 44 provides search results to aid in the brainstorming effort, and the user can decide whether to save any data from the search results by entering them in the region 52. The data that the user chooses to enter may be those based on the search results or even data unrelated to (independent of) the search results, if the user deems it appropriate to record them. For convenience, in this embodiment all data entered in the region 52 will are saved automatically, but the invention is not limited as such.

The preceding description discusses the usage of the information window 44 as a convenient tool for obtaining and recording data relevant to a node, but the same functionality is available for obtaining and recording data relevant to a relationship. FIG. 5 illustrates such usage with the relationship 30 between the Japan node 20 and the typhoon node 24. In this example, selecting the relationship 30 causes a menu 58 to appear. Options on the menu include deleting the relationship 30 and opening an information window 44 for data gathering and recording. The invention is not limited to including only these two options, though.

In this embodiment, an information window for a relationship functions differently from an information window for a node in that the information window for a relationship uses two labels, those of each of the two nodes connected by the relationship, as search terms for the search engine that the user selects for use with the information window. Accordingly, an information window for the relationship 30 would provide “Japan” and “typhoon” as the search terms for the chosen search engine.

Another way the server 12 assists a user's brainstorming efforts to provide suggestions for new nodes to create. Such is a useful feature not only for a group of individuals collaborating in a brainstorming session but also for a lone user searching for information and desiring contributions of past users of the system (discussed below). The server 12 segments the information it can access into two realms, which can be designated the “objective” and the “subjective” realms. That is, an item of information can have an innate characteristic (objective information), and then the item can create an impression to a user or be described in a particular matter (subjective information). Setting aside arguments that all information can be regarded as subjective or that a user can have an opinion on an opinion, by defining simple rules to classify information as objective or subjective allows for the creation of a bank of knowledge that has a clean structure for placing a synchronization point of knowledge sharing. Following this primitive directive enables easy extrapolation into any level of complexity, as defining in a relativistic manner that when commenting on a subjective statement, the subject becomes the object in relevance to the opinion. Again, there is a clear point for knowledge synchronization.

With reference to the mind map 18 in FIG. 2, selecting the appropriate option from the menu 42 opens a list of suggestions (not shown for clarity) for a new node to be created as directly connected to the typhoon node 24. The server 12 provides the suggestions by accessing the graph database 14 and executing an algorithm (or set of algorithms) that provides the user at least the following four options:

In this embodiment, the first and second options are default options. When exercising the first option, suggestions for new nodes to be connected directly to a given node (such as the typhoon node 24) are generated based on nodes that users in the past have directly connected to nodes of the same name (that is, also “typhoon”) in their mind maps. When exercising the second option, the algorithm(s) ranks the node suggestions according to popularity, that is, how often a particular suggested node has been used in the past.

In this embodiment, third and fourth options function effectively as filters that enable a user to specify the sources of suggestions. When exercising the third option, a factor ranking the suggestions for nodes is who used a particular suggested node in the past. More specifically, if the algorithm determines that node choices of a particular user are often adopted by subsequent users in response to their queries for suggestions, the subsequent node choices of that particular user will be rated higher. If the user elects to exercise the fourth option, node suggestions are ranked according to contextual vectorization, that is, a machine learning engine provides suggestions based on contextual proximity and alikeness.

For example, a user can filter out suggestions originating from people who do not live in Japan, if he/she desires. The user can also filter according to other characteristics, that is, according to pre-defined groups to which users belong, such as age, gender, country or city of residence, universities where other users studied, and so on.

The preceding algorithm can be regarded as the suggestion engine for new nodes. A similar engine may be used when a user accesses an information window and exercises his/her option to use the system internal search engine functionality that searches the associated graph database(s) for information relating to a node. Note, for example, option SE3 of FIG. 4 (discussed above).

The system 10 allows the second user to load the mind map 18 on the display of the second client computer 38 (unless the server 12 has blocked access). Thus, even though the second user may be located in a different part of the world, he/she may still participate in the brainstorming session by viewing the first user's contributions to the mind map 18 and also by adding/revising/deleting nodes and relationship. (As noted above, such interaction need not supplant a conference call. Instead the join mind map access augments the brain storming effort.) Additionally, the second user may access information windows and view the notes of the first user and comment as the second user deems appropriate. Accordingly, when the first user opens and uses an information window or requests suggestions for another node to create, the data he/she receives can include data that another user has provided to the graph database 14 using a different client computer.

The functionality described above regarding the first embodiment also enables brainstorming among participants without requiring that the individual members of the team participate at the same time. One user of the system 10 can easily view the mind map 18 and the notes in the information boxes that another user has created or altered. That other user can then view the additions/revisions/deletions of the first user. Without requiring that all participants be available at the same time, the brainstorming can advance at a faster rate.

In the embodiment just described, multiple users participate in collaborative brainstorming in what can be regarded as a single extended session, even though the users could participate at different times. They still shared the common goal, whether to solve a particular problem, to plan futures events, et cetera. In other embodiments, though, a lone user by himself/herself can search for information by accessing information that other users have contributed in the past. Thus, the “lone” user essentially participates in a brainstorming station with potentially all users that have ever contributed to the system.

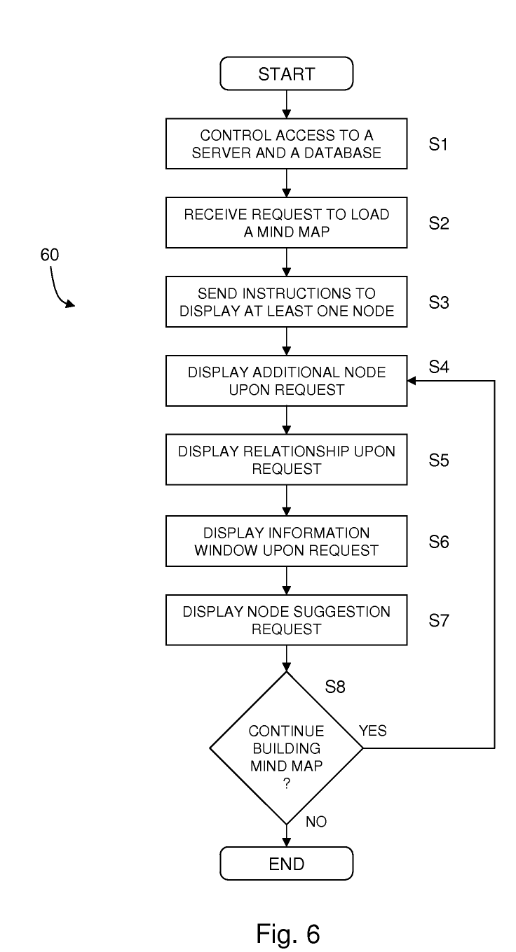

The invention may also be embodied as a method of storing and retrieving information, and this method will be discussed now with reference to the flow chart 60 of FIG. 6. The ability to conveniently store and retrieve information improves brainstorming sessions as discussed above.

The first step of the present embodiment is to control access to a server and a database. (Step S1.) A single administrator can be responsible for controlling the server to grant or deny access to users to a brainstorming session and accordingly to the database. Multiple servers may be implemented instead of one server, and the administrator would have control over all of them. Similarly, multiple databases may be implemented instead of only a single database. The database(s) may be a graph database(s). Alternate types of databases may also be implemented as discussed above.

The next step of the method of storing and retrieving information is to receive at the server a request from a user to load a mind map on a display of the user's client computer. (Step S2.) The mind map can be loaded by creating a new mind map or by retrieving a mind map that is stored on the database. The mind map may have been created by a different user from the user that sent the request to load the mind map.

After receiving the request from the user, the next step is to send from the server instructions to display for the user at least one node of the mind map on the display. (Step S3.) A single node only may be all that is displayed when the request from Step S2 is to create a new mind map, as the user is starting with one node. If the request from Step S2 is to retrieve an existing mind map, the instruction sent in Step S3 will of course probably be to display more than one node and the relationship(s) between the nodes.

In building or revising the mind map, the user will need to send requests to the server for instructions to display additional nodes and relationships between nodes. Accordingly, the method continues with the server responding to the requests by sending instructions to display on the user's display an additional node of the mind map (Step S4) and a relationship between the first node and the additional node (Step S5).

An individual member of a brainstorming team will naturally want the assistance of others from time to time. For example, the user building/revising the present mind map way want to open an information window or to receive suggestions for new nodes as discussed above regarding previous embodiments of the invention.

For example, regarding the information window, data from other members of the brainstorming team or from publically-available resources accessed via the Internet can be presented by an information window that displays search results associated with a node or with a relationship. The information window also enables a user to enter for storage on the database data based on the search results or alternatively data that are independent of the search results. The user may enter both types of data.

The information window may enable the first user to select one or more resources from a plurality of resources, and the selected resource would provide the search results displayed in the information window. One example resource is an Internet search engine accessing the Internet. Another example resource is search engine functionality within the server used to access the controlled-access database to provide search results therefrom.

Regarding the suggestions for another node, the server provides these by accessing the controlled-access database. With such a configuration, the search results and/or the suggestions can include data for the brainstorming team member that a second team member (a “second user”) using a second client computer has provided to the controlled-access database.

Thus, the method continues with the server responding to requests from the first user to display on the client computer's display an information window and/or a request from the user to display suggestions for another node to create by sending instructions to display the information window (Step S6) and/or the suggestions for another node to create (Step S7). It is noted that in the practice of the present method sometimes a user will request only information windows, sometimes only suggestions for additional nodes to create, and sometime both.

It is further noted that in alternate embodiments, the order of the steps may differ. As a non-limiting example, steps S6 and S7 may be reversed.

Returning to the present embodiment, it is queried whether the user wants to continue building the mind map. (Step S8.) For example, the user may want to add more nodes. If the answer is affirmative, the process flow returns to step S4, and a new node will be displayed, if requested. If the answer to the query of step S8 is negative, the method is deemed completed at this point.

As discussed above regarding system embodiments, the invention can be embodied as a method in which a single user independently searches for information by accessing past data generated based on contributions of other users in the past.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A system for storing and retrieving information, the system comprising:
one or more databases for storing mind maps that have nodes and relationships between the nodes;
one or more servers under common control that control access to the one or more databases and, through a network, communicate with a first client computer of a first user, the one or more servers being operative to receive a request from the first user to load a mind map on a display of the first client computer, to send instructions to the first client computer to display at least a first node of the mind map, and, upon request from the first user, to send to the first client computer instructions to display (1) an additional node of the mind map, (2) a relationship between the first node and the additional node, and (3) at least one of (i) an information window and (ii) suggestions for another node to create;
wherein the information window displays search results associated with the first node, with the additional node, or with the relationship and enables the first user to enter for storage on the one or more databases data based on the search results and data independent of the search results;
wherein the suggestions for another node are provided by accessing the one or more databases, and
wherein the search results and/or the suggestions include data that a second user has provided to the one or more controlled-access databases using a second client computer.

2. The system of claim 1, wherein the one or more databases are graph databases.

3. The system of claim 1, wherein the request to load a mind map is a request to create a new mind map.

4. The system of claim 1, wherein the request to load a mind map is a request to retrieve a mind map that is stored on the one or more databases.

5. The system of claim 4, wherein the mind map was created by the second user using the second client computer.

6. The system of claim 1, wherein instructions are sent from the one or more servers to display on the display both an information window and suggestions for another node to create.

7. The system of claim 1, wherein the one or more servers enable the first user to select at least one resource from a plurality of resources, the selected resource providing the search results displayed in the information window.

8. The system of claim 7, wherein the selected resource is an Internet search engine accessing the Internet.

9. The system of claim 7, wherein the one or more servers has search engine functionality, and the selected resource is the one or more servers accessing the one or more databases to provide search results therefrom.

10. A method of storing and retrieving information, the method comprising:
controlling access to one or more servers and to one or more databases;
receiving at the one or more servers a request from a first user to load a mind map on a display of a first client computer;
sending from the one or more servers instructions to display at least a first node of the mind map on the display; and
upon request from the first user, sending from the one or more servers instructions to display on the display (1) an additional node of the mind map, (2) a relationship between the first node and the additional node, and (3) at least one of (i) an information window and (ii) suggestions for another node to create;
wherein the information window displays search results associated with the first node, with the additional node, or with the relationship and enables the first user to enter for storage on the one or more databases data based on the search results and data independent of the search results;
wherein the suggestions for another node are provided by accessing the one or more controlled-access databases, and
wherein the search results and/or the suggestions include data that a second user has provided to the one or more controlled-access databases using a second client computer.

11. The method of claim 10, wherein the one or more databases are graph databases.

12. The method of claim 10, wherein the request to load a mind map is a request to create a new mind map.

13. The method of claim 10, wherein the request to load a mind map is a request to retrieve a mind map that is stored on the one or more databases.

14. The method of claim 13, wherein the mind map was created by the second user using the second client computer.

15. The method of claim 10, wherein instructions are sent from the one or more servers to display on the display both an information window and suggestions for another node to create.

16. The method of claim 10, further comprising:
enabling the first user to select at least one resource from a plurality of resources, the selected resource providing the search results displayed in the information window.

17. The method of claim 16, wherein the selected resource is an Internet search engine accessing the Internet.

18. The method of claim 16, wherein the one or more servers has search engine functionality, and the selected resource is the one or more servers accessing the one or more controlled-access databases to provide search results therefrom.

19. The method of claim 10, wherein the suggestions for another node are generated based on (1) nodes that previous users have chosen to directly connect to nodes having the same name and on (2) how often a particular suggested node has been connected in the past.

20. The method of claim 19, wherein the suggestions for another node are filtered according to pre-defined groups to which users belong.
